(19) United States
(12) Patent Application Publication
(10) Pub. No.: US 2008/0143170 A1
(43) Pub. Date: Jun. 19, 2008

(54) Light-Metal Wheel

(75) Inventor: Heinrich Baumgartner, Schiltach (DE)

Correspondence Address: WOOD, PHILLIPS, KATZ, CLARK & MORTIMER, 500 W. MADISON STREET, SUITE 3800, CHICAGO, IL, 60661, US

(73) Assignee: BBS Motorsport & Engineering GmbH, Schiltach (DE)

(21) Appl. No.: 11/629,757

(22) PCT Filed: Jun. 14, 2005
(86) PCT No.: PCT/EP05/06368

§ 371 Date: Sep. 6, 2007

(30) Foreign Application Priority Data
Jun. 16, 2004 (DE) 10 2004 028 841.0

(51) Int. Cl. B60B 21/02

(52) U.S. Cl. 301/30

(57) ABSTRACT

The invention relates to a wheel, especially a light-metal wheel for motor vehicles, consisting of a star of spokes (12) and a wheel rim (10) provided with an inner base (16) and an outer base (14) that respectively merge into an inner rim end (20) on the inner side of the wheel and into an outer rim end (18) on the outer side of the wheel. A hollow chamber (26, 27, 29) extending at least partially continuously in the peripheral direction is formed in the region of the inner side of the wheel and/or the outer side of the wheel, and can be defined by a profiled wall (28) in the region of the inner base (16) of the rim or the outer base (14) of the rim. In order to create an especially cost-effective structure that can be subjected to mechanical stresses, the profiled wall (28) is embodied as a single component.

The invention relates to a wheel, particularly a light metal wheel for motor vehicles, in accordance with the introductory portion of claim 1.

In light metal wheels, the desired reduction of weight is frequently accompanied by a reduction of sturdiness and durability. In order to create a wheel that provides a reduction of weight relative to conventional wheels and an improvement of the mechanical characteristics, it was proposed, in WO 01/17799 A1, to use profiled segments that form a hollow chamber extending at least partially continuously in the circumferential direction of the wheel in the area of the inner rim base or of the outer rim base, respectively. Half shells, which were used in the area of the inner rim base or of the outer rim base, respectively, and which were connected both with one another as well as with the adjacent elements of the wheel by means of appropriate methods of attachment, were preferentially suggested as profile elements. The manufacture and assembly of wheels designed in such a way proved to be relatively complicated and expensive, however.

The problem that forms the basis for the invention, therefore, is that of further developing a wheel, particularly a light metal wheel for motor vehicles, in such a way that it can, while still maintaining the reduction of weight and the high mechanical load bearing capacity, simultaneously be produced in a particularly cost-effective manner, and be easy to assemble.

This problem is solved by a wheel with the characteristics of claim 1.

In accordance with the invention, a hollow chamber extending at least partially continuously in the circumferential direction of the wheel is formed in the area of the inner side of the wheel and/or of the outer side of the wheel, which [chamber] can be bounded, in the area of the inner rim base or of the outer rim base, by a profiled wall, whereby the profiled wall is formed as one piece. Low manufacturing costs, as well as a simple assembly of the wheel upon the manufacture of the upper cover of the hollow chamber, thereby result.

In accordance with one preferred embodiment of the invention, the profiled wall is formed from a circular full shell, which is slid into the desired area of the inner rim base or of the outer rim base, respectively, and can be attached there. A particularly simple mounting of the wheel consequently results.

The full shell is preferably slid from the outer side of the wheel into the area of the outer rim base, as the result of which the full shell is easily accessible from the outside.

If the full shell additionally has at least one bar positioned in the direction of the wheel center, which [bar] is screwed together with at least one spoke of the wheel center, the connection between the full shell and the remaining elements of the wheel is produced in a particularly simple and secure manner.

In accordance with another embodiment of the invention, the full shell is slid from the inner side of the wheel into the area of the outer rim base, and the area of the inner rim base is deformed in a chip-free manner, so that the insertion of the full shell takes place without leaving behind a molding seam that is visible from the outside.

In accordance with an additional embodiment of the invention, the profiled wall is integrally formed with the wheel, as the result of which the manufacturing costs are reduced considerably.

The profiled wall is preferably formed as an annular bar that can be deformed in a chip-free manner in the area of the outer rim end, which [end] can be deformed inwardly, so that a stable support surface for the tire is formed on the inner side of the wheel in the area of the outer rim base, even without means of attachment between the profiled wall and the wheel.

The profiled wall advantageously forms, in the deformed condition, at least the upper section of the outer rim end, as the result of which a simple accessibility is ensured.

A hollow chamber is advantageously formed in the inner rim end and/or in the outer rim end through the deformation of the profiled wall, as the result of which the inner rim end or the outer rim end, respectively, additionally gains stability.

The process in accordance with the invention for the manufacture of a wheel has the following steps:
Casting of a molded blank with a wheel center and a section proceeding perpendicularly to the same with four radial circular annular bars;
Forward rotation of the contour of the wheel rim in the section and of a support surface on the annular bar forming the outer rim end;
Drawing the section and reshaping the annular bar forming the profiled wall for the formation of the cavity bordering on the outer rim end;
Forward rotation of a support surface on the annular bar forming the inner rim end; and:
Reshaping the annular bar forming the profiled wall for the formation of the cavity bordering on the inner rim end.

In one embodiment of the process in accordance with the invention, the reshaped annular bars are attached to the annular bars forming the outer rim end or the inner rim end, respectively, by means of welding, preferably by means of laser welding. This work step can also be omitted, however, since the solidity is already ensured through the supporting of the profiled walls against the outer rim end or the inner rim end, respectively.

Additional details, characteristics and advantages of the present invention result from the following description, with reference to the diagrams. These depict the following:

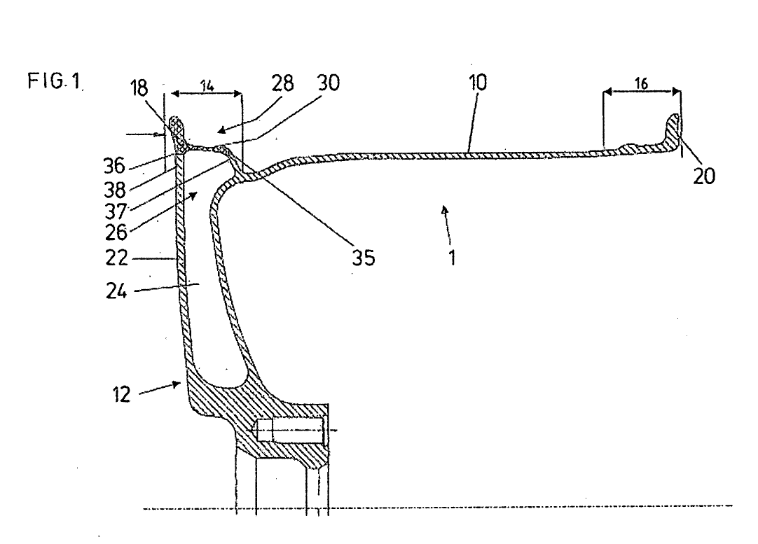

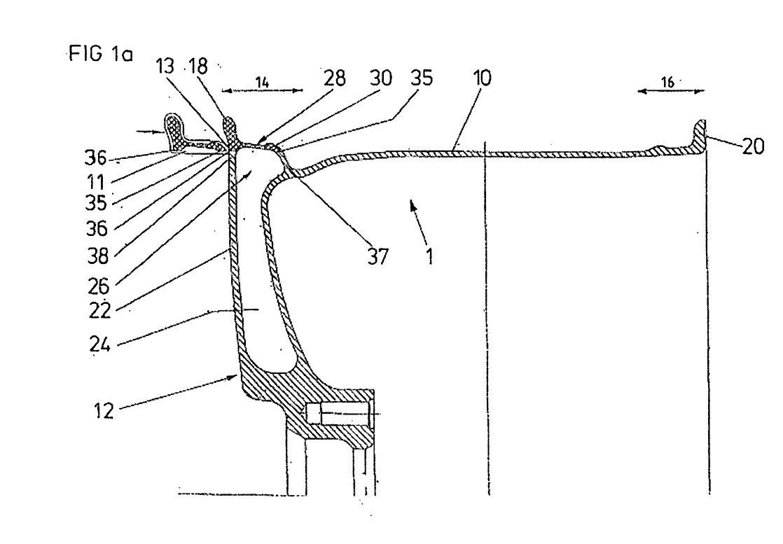

FIG. 1: A first embodiment of the wheel in accordance with the invention, in a half-section;

FIG. 1a: A schematic representation of the manufacturing process of the first embodiment of the wheel in accordance with the invention, in accordance with FIG. 1, in a half-section;

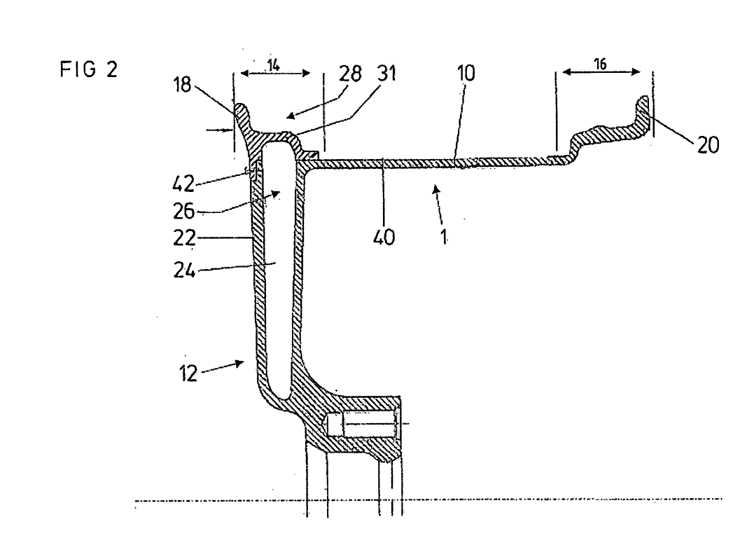

FIG. 2: A second embodiment of the wheel in accordance with the invention, in a half-section;

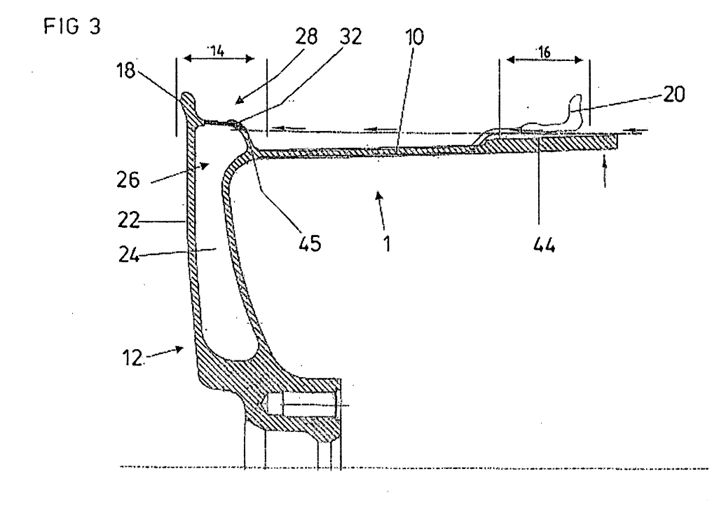

FIG. 3: A third embodiment of the wheel in accordance with the invention, in a half-section;

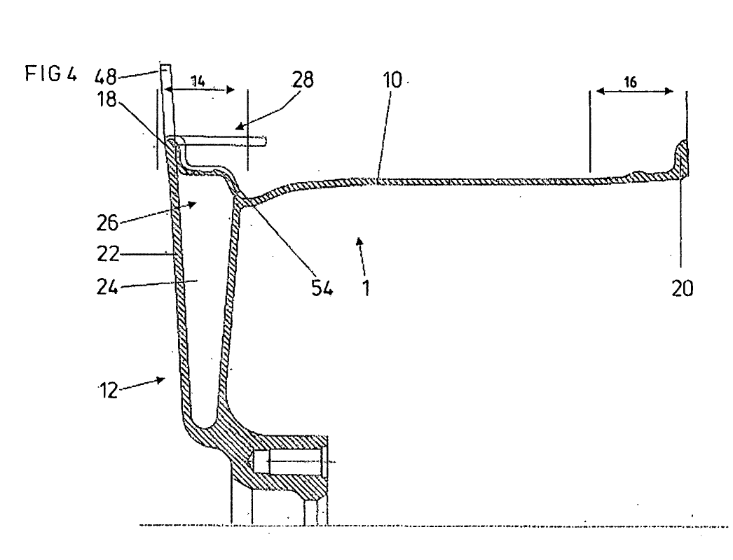

FIG. 4: A fourth embodiment of the wheel in accordance with the invention, in a half-section;

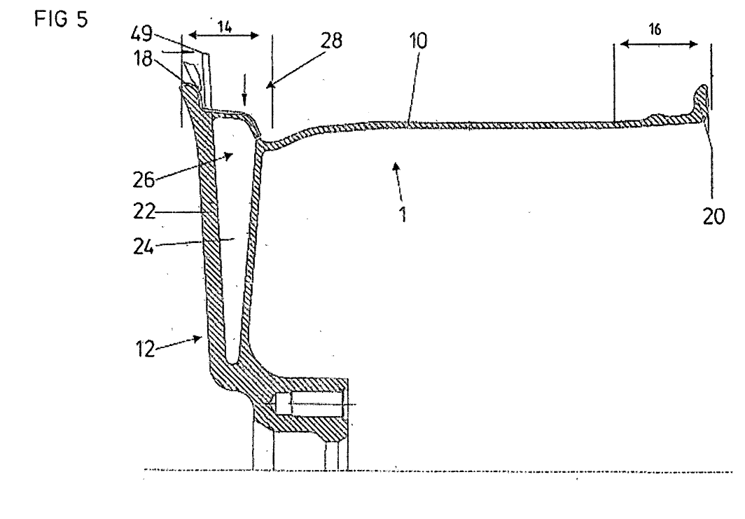

FIG. 5: A fifth embodiment of the wheel in accordance with the invention, in a half-section;

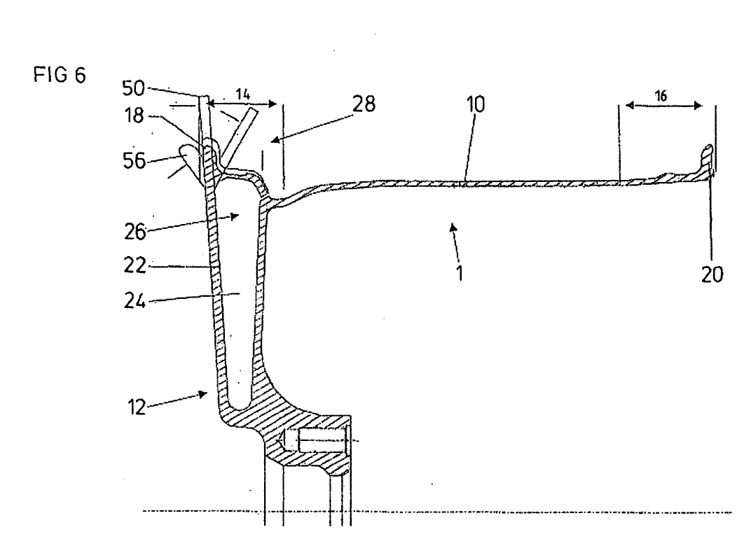

FIG. 6: A sixth embodiment of the wheel in accordance with the invention, in a half-section;

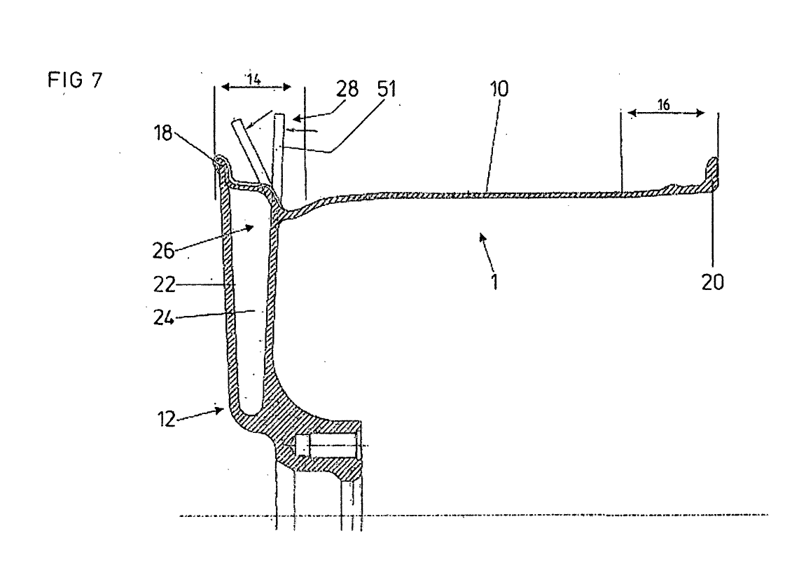

FIG. 7: A seventh embodiment of the wheel in accordance with the invention, in a half-section;

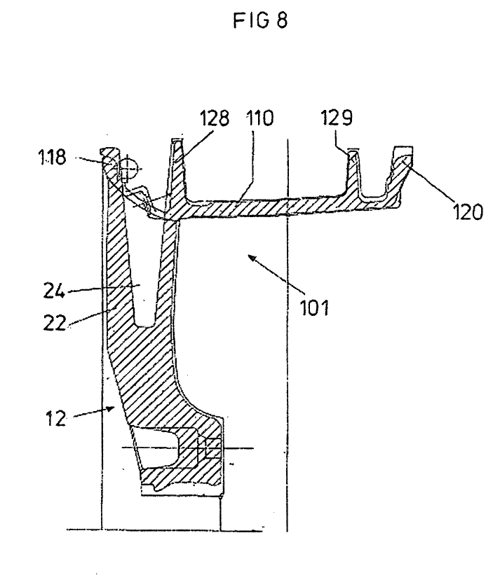

FIG. 8: A molded blank, in a half-section;

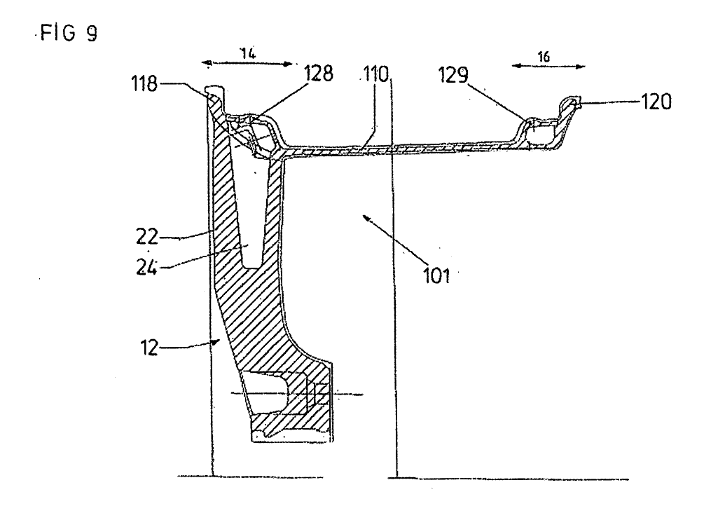

FIG. 9: The molded blank from FIG. 8 after stretching, in a half-section;

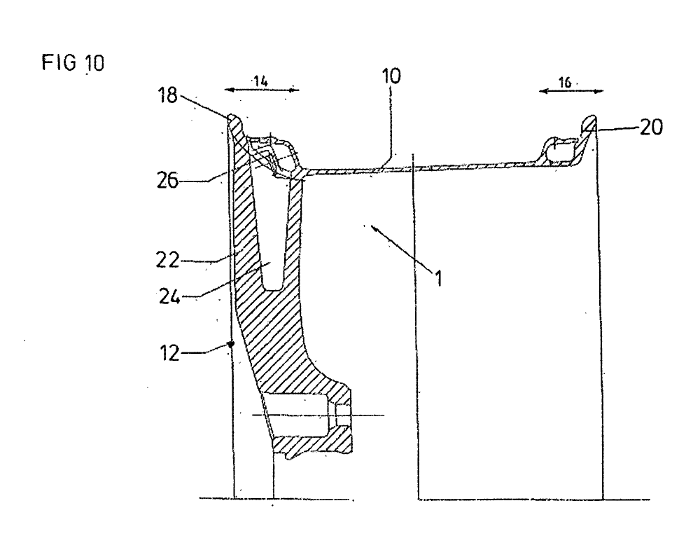

FIG. 10: The molded blank from FIG. 9, after mechanical processing;

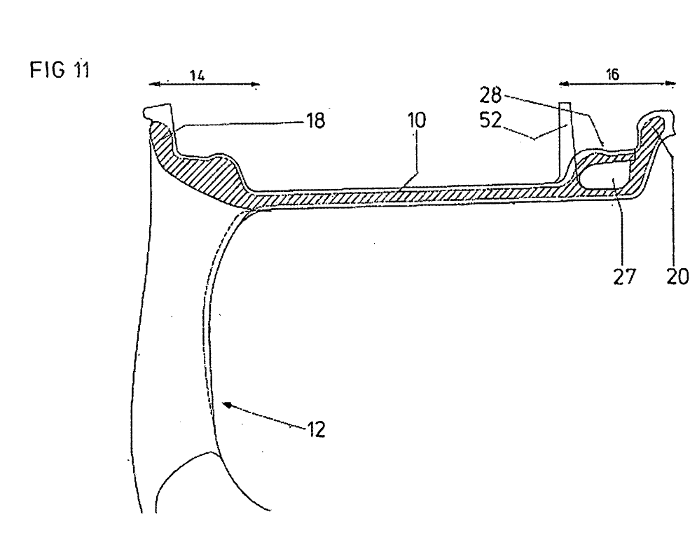

FIG. 11: An eighth embodiment of the wheel in accordance with the invention, in a half-section;

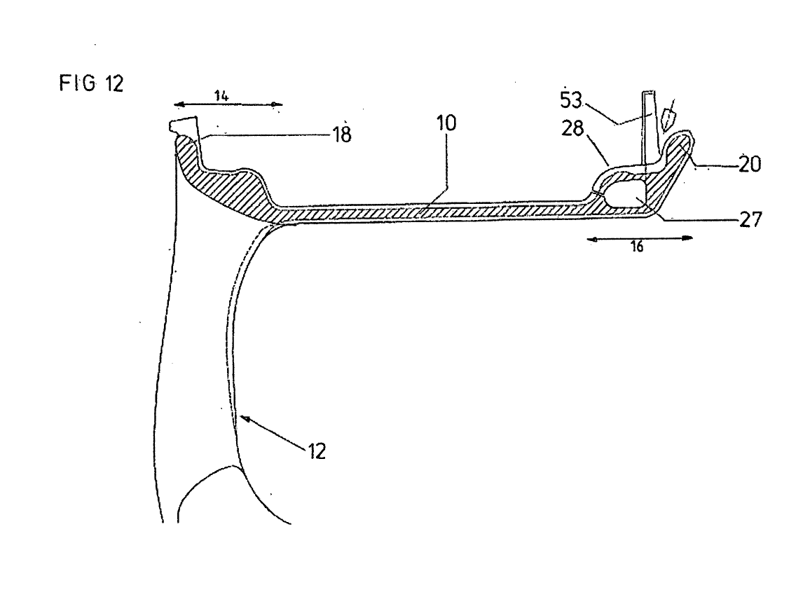

FIG. 12: A ninth embodiment of the wheel in accordance with the invention, in a half-section;

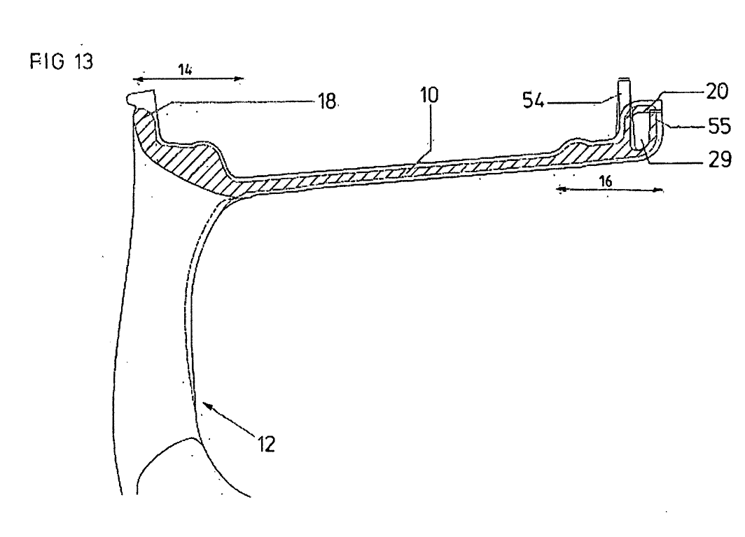

FIG. 13: A tenth embodiment of the wheel in accordance with the invention, in a half-section.

The fundamental structure of the wheel is identical in all of the embodiments. The wheel (1) consists, as is normally the case, of a wheel rim (10) and a wheel center (12).

The wheel rim (10) has an outer rim base (14) and an inner rim base (16). The outer rim base (14) merges on the outer side of the wheel into an outer rim end (18), whereas the inner rim base (16) merges on the inner side of the wheel into an inner rim end (20). A tire (not depicted) is held between the outer rim end (18) and the inner rim end (20), which [tire] is supported on the outer rim base (14) and the inner rim base (16), and is applied laterally against the outer rim end (18) and the inner rim end (20).

The wheel center (12) has a multiplicity of spokes (22) which are, in order to save weight, generally designed as hollow spokes, and can have one spoke cavity each (24).

A hollow chamber (26) extending at least partially continuously in the circumferential direction is formed in the area of the outer side of the wheel, which [hollow chamber] is positioned here in the area of the outer rim base (14). It is also possible, however, to produce a hollow chamber (27) in the area of the inner rim base (16) (compare: FIGS. 11, 12, and 13). A communicating connection (not depicted) is usually present in the area of the spokes (22), between the spoke cavities (24) and the circular hollow chamber (26), as the result of which an extremely stable and, at the same time, rigid hollow chamber construction, which provides for an improved impact behavior, is brought about.

The hollow chamber (26) is in each case bounded by a profiled wall (28) in the area of the outer rim base (14), which [wall] serves, at the same time, as a support surface for the tire. In an analogous manner, the hollow chamber (27) is bounded, in the area of the inner rim base (16), by a profiled wall (28), which [wall] likewise serves as a support surface for the tire. The profiled wall (28) can, in an alternate or additional manner, be reshaped in such a manner that a hollow chamber (29) is formed inside the inner rim end (20) (compare: FIG. 13) or the outer rim end (18), respectively, so that the profiled wall (28) and the hollow chamber (29) formed support the tire towards the outside.

In all embodiments, this profiled wall (28) is preferably formed from so-called ductile materials which can be reshaped in cold form, or from casting alloys, which can be reshaped in warm form. In the embodiments in accordance with FIG. 1 to 3, it is also always possible to manufacture the profiled wall (28), and the remaining elements of the wheel, from a corresponding material, preferably the alloys WN AC-ALSi12Mg or EN AC-ALSi7Mg.

In the embodiment in accordance with FIG. 1, the profiled wall (28) consists of a full shell (30), which comprises most of the outer rim base (14) and the outer rim end (18). The circular full shell (30) is produced separately from the remaining elements of the wheel (1), and has two plane contact surfaces (35, 36) in the area of the outer rim base (14) or of the spokes (22), respectively, which can be connected with two corresponding bars (37, 38) of the wheel. For this purpose, the full shell (30) can be slid from the outer side of the wheel onto the wheel until the contact surfaces (35, 36) and the bars (37, 38) are located in the correct position in relation to one another. The attachment is subsequently preferably carried out by means of connection techniques that are already known per se, such as welding or adhesion, for example.

The full shell (30) is, in an advantageous manner, integrally cast as a flange (11) displaced axially outwardly onto the wheel (1), is separated from the wheel (1) at a contact point (13), and, after a chip-eliminating processing for the production of the desired form of the full shell (30), as has been described above, is placed with the contact points (35, 36) on the bars (37, 38) (compare: FIG. 1a). In this way, it is guaranteed that the full shell (30) has been cast under the same conditions as the wheel (1).

A similar embodiment is depicted in FIG. 2, but the full shell (31) extends further towards the inner side of the wheel, however, where it is supported on a long, flat middle section (40) of the rim (10). Underneath the outer rim end (18), the full shell (31) additionally has a bar (42) positioned in the direction of the wheel center (12), which [bar] engages with a corresponding recess in the wheel center (12) and can be screwed together with the same, possibly upon use of an appropriate sealing material. This construction is particularly robust, and permits a simple mounting/dismounting of the full shell (31). The full shell (31) can likewise be connected with this in the area of the level surface (40) of the wheel rim (10), if necessary, by means of the connection means noted above. Such a type of construction therefore also provides a simple possibility for the accommodation of a support body on the level surface (40) for purposes of emergency operation.

In accordance with the embodiment depicted in FIG. 3, the full shell (32) is only formed as a part of the outer rim base (14), whereas the outer rim end (18) is produced as a single piece with the basic framework of the wheel (1). An insertion of the full shell (32) from the outer side of the wheel is therefore not possible. Instead of this, the basic framework of the wheel first of all has only one level circular base surface (44) in the area of the subsequent inner rim base (16), through which the full shell (32) can be slid from the inner side of the wheel until the connection with the outer rim end (18) and the bar (45) provided for that purpose is produced in the area of the outer rim base (14). The known connection techniques noted above are also used here. Finally, the level base surface (44) is deformed in such a manner that a suitable inner rim base (16), as well as inner rim end (20), results.

In FIGS. 4 to 6, embodiments are depicted in which the profiled wall (28) is formed, in the area of the outer rim base (14), from circular annular bars (48, 49, 50) integrally formed with the wheel bar. In an analogous manner, FIG. 12 depicts an embodiment in which the profiled wall is formed in the area of the inner rim base (16) on a circular annular bar (53) integrally formed with the wheel bar. The molded blank, which specifically forms the annular bar (48, 49, 50, 53), is likewise depicted, as an interim condition during the deformation, as a white surface with a black contour, while the final condition is depicted with cross-hatching. After the deformation, material is removed from the annular bars (48, 49, 50, 53) molded out in the molded blank on the outer side in order to achieve the desired thickness and form of the profiled wall (28). In particular, a circular groove is worked into the profiled wall (28), in which [wall] the tire is supported both internally as well as also externally.

FIG. 4 depicts one particularly simple variant, in which the annular bar (48) forms only an extension of the wheel center (12) and is bent back towards the inner side of the wheel in such a manner that both an outer rim base (14) is formed, as well as a bar (54) for the connection with the wheel rim (10). Because of the geometry of the bent profiled wall (28), this embodiment is capable of bearing heavy loads.

In the embodiment depicted in FIG. 5, the outer rim end (18) is formed separately from the annular bar (49), which can be split off from the same through the use of appropriate means of separation and shifted inwardly. As depicted in FIG. 12, the annular bar (53) can, in an analogous manner, also be integrally formed separately from the inner rim end (20), which can be shifted inwardly in order to form the circular hollow chamber (27).

FIG. 6 depicts a similar embodiment whereby, in this case, the annular bar (50) has a second projection (56) projecting away at an angle, which [projection] forms, after the process of deformation, the outer rim end (18).

It is likewise possible to position an annular bar (51) in the area of the outer rim base (14), which can be deformed outwardly and, if desired, enclose the wheel center (12) there from above in the area of the outer rim end (18) (compare: FIG. 7). FIG. 11 depicts an additional embodiment in which an annular bar (52) is, in an analogous manner, positioned in the area of the inner rim base (16), which is deformed towards the outside. In this example of implementation, the inner rim end (20) is not enclosed from above by the reshaped annular bar (52), however, but instead lies on a gradation on the side of the inner rim end (20) oriented towards the wheel rim (10).

In the embodiments depicted in FIGS. 4 to 7, a connection of the deformed bar with the surfaces positioned directly opposite is possible but not absolutely necessary, since a sufficient load bearing capacity is already provided through the deformation.

FIG. 13 depicts one additional preferred embodiment, in which an annular bar (54) is positioned in the area of the inner rim base (16) in such a manner that, after the deformation of the annular bar (54) outwardly onto a circular annular bar (55) through the annular bars (54 and 55), the inner rim end (20) is formed with a circular hollow chamber (29) formed in the interior. An inner rim end (20) formed in such a manner has an increased stability with a lower weight. An outer rim end, which has a hollow chamber, can also be formed from two circular annular bars in an analogous manner (not depicted). Furthermore, there is also a possibility of placing a circular hollow chamber both in the area of the inner rim base or of the outer rim base, respectively, as well as in the inner rim end or in the outer rim end, respectively.

Many additional geometrical embodiments which have not previously been described, but which implement the concepts in accordance with the invention, are also conceivable.

The process for manufacturing a wheel in accordance with the invention in accordance with an embodiment depicted in FIGS. 4 to 7 should be described by means of FIGS. 8 to 10.

FIG. 8 depicts a molded blank (101) in a half-section, which already shows the wheel center (12) with the spokes (22) and has a section (110) proceeding perpendicularly to the same, from which the wheel rim (10) is worked. The section (110) has four annular bars proceeding radially (118, 120, 128, 129). The molded blank (101) is cast from an aluminum alloy, such as from the alloys WN AC-ALSi12Mg or EN AC-ALSi7Mg, for example.

After the cooling off of the molded blank (101), the contour of wheel rim (10) is rotated forward in the section (110). A support surface for the annular bar to be reshaped (128) is thereby rotated on the annular bar (118). The annular bar (128) is subsequently bent back outwardly, possibly after a chip-eliminating processing, so that the free end of the annular bar (128) is supported on the support surface in the annular bar (118) and the outer rim base (14) is formed. Furthermore, the section (110) is drawn in order to determine the definitive width of the wheel rim (10).

A support surface for the annular bar to be reshaped (129) is subsequently rotated on the annular bar (120), and the annular bar (129) is bent back outwardly, possibly after a chip-eliminating processing, until it is supported on the support surface in the annular bar (129), through which the inner rim base (16) is formed (compare: FIG. 9).

Both of the reshaped annular bars (128 and 129) can be attached to the support surfaces of the annular bars (118 and 120) by means of welding, preferably by means of laser welding, either at points or by means of a completely encircling welding seam. The cavity (26) formed by the profiled walls (28) can be tightly sealed by means of a completely circular welding seam. Such an attachment, however, is not necessary for reasons of solidity; in order to achieve the effect essential to the invention, it is already sufficient if the annular bars (128 and 129), or the profiled walls (28) formed from them, respectively, are supported against the outer rim end (18) formed from the annular bar (118), or against the inner rim end (20) formed from the annular bar (120), respectively. The additional manufacturing step of welding, which entails additional work and costs, can thus be preferably dispensed with.

The molded blank (101) is, in the known manner, subsequently subjected to a thermal treatment in order to eliminate the tensions in the material that come about from the deformation steps.

A mechanical chip-eliminating processing of the molded blank (101), in which the outer rim end (18) is worked from the annular bar (118), while the annular bar (120) is used for the formation of the inner rim end (20), likewise follows in the known manner. On the surface of the annular bars (128 and 129), material is removed for the formation of the profiled walls (28) in the area of the inner rim base (16) and of the outer rim base (19). In particular, a circular groove is thereby worked into the outer side of the profiled walls (28), in which groove the tire can be supported both inwardly as well as also outwardly.

After achieving the desired form of the wheel (1) (compare: FIG. 10), a surface coating, such as coating of paint, for example, is applied to the wheel (1).

The process described is obviously also applicable to the manufacture of wheels in accordance with the invention which only have a profiled wall (28) in the area of the outer rim base (14), or only in the area of the inner rim base (16).

1) A wheel, particularly a light metal wheel for motor vehicles, essentially consisting of a wheel center (12) and a wheel rim (10), whereby the wheel rim has an inner rim base (16) and an outer rim base (14), which merge into an inner rim end (20) on an inner side of the wheel or into an outer rim end (18) on an outer side of the wheel, respectively, whereby a hollow chamber (26, 27, 29) extending at least partially continuously in the circumferential direction is formed in the area of the inner side of the wheel and/or the outer side of the wheel, which can be bounded by a profiled wall (28) in the area of the inner rim base (16) or of the outer rim base rim (14), respectively, characterized in that, the profiled wall (28) is formed as a single part.

2) A wheel in accordance with claim 1, characterized in that, the profiled wall (28) is formed from a circular full shell (30, 31, 32).

3) A wheel in accordance with claim 2, characterized in that, the full shell (30, 31, 32) is slid into the area of the inner rim base (16) or of the rim outer base (14), respectively, and is attached there.

4) A wheel in accordance with claim 2 or 3, characterized in that, the full shell (30, 31) is slid from the outer side of the wheel into the area of the outer rim base (14).

5) A wheel in accordance with claim 4, characterized in that, the full shell (30, 31) forms at least a portion of the outer rim base (14) as well as the outer rim end (18).

6) A wheel in accordance with claim 5, characterized in that, the full shell (31) has at least one bar (42) directed in the direction of the wheel center, which is screwed together with at least one spoke (22) of the wheel center (12).

7) A wheel in accordance with claim 2 or 3, characterized in that, the full shell (32) is slid from the inner side of the wheel into the area of the outer rim base (14), and the area of the inner rim base (16) is deformed in a chip-free manner.

8) A wheel in accordance with claim 1, characterized in that, the profiled wall (28) is integrally formed with the wheel.

9) A wheel in accordance with claim 8, characterized in that, the profiled wall (28) is formed as a circular bar that can be deformed in a chip-free manner (48, 49, 50, 51, 52, 53, 54).

10) A wheel in accordance with claim 9, characterized in that, the circular bar (48, 49, 50) is positioned in the area of the outer rim end (18) and can be deformed inwardly.

11) A wheel in accordance with claim 9, characterized in that, the circular bar (51) is positioned in the area of the outer rim end (18) and can be deformed outwardly.

12) A wheel in accordance with claim 9, characterized in that, the circular bar (53) is positioned in the area of the inner rim end (20) and can be deformed inwardly.

13) A wheel in accordance with claim 9, characterized in that, the circular bar (52) is positioned in the area of the inner rim end (20) and can be deformed outwardly.

14) A wheel in accordance with one of the claims 8 to 13, characterized in that, the profiled wall (28), in the deformed condition, forms at least the upper section of the outer rim end (18).

15) A wheel in accordance with one of the claims 8 to 14, characterized in that, a hollow chamber (29) is formed in the inner rim end (20) and/or in the outer rim end (18) through the deformation of the profiled wall (28).

16) A process for manufacturing a wheel in accordance with one of the claims 8 to 15, with the steps:
Casting of a molded blank (101) with a wheel center (12) and a section (110) proceeding perpendicularly to the same with four radial circular annular bars (118, 120, 128, 129);
Forward rotation of the contour of the wheel rim (10) in the section (110) and of a support surface on the annular bar (118);
Drawing the section (110) and reshaping the annular bar (128);
Forward rotation of a support surface on the annular bar (120); and:
Reshaping the annular bar (129).

17) A process in accordance with claim 16, characterized in that, the annular bars (128, 129) are subsequently attached to the annular bars (118, 120) by means of welding.

18) A process in accordance with claim 16 or 17, characterized in that, the molded blank (101) is subsequently subjected to a thermal treatment.

19) A process in accordance with one of the claims 16 to 18, characterized in that, a chip-eliminating processing of the molded blank (101) is carried out.

20) A process in accordance with one of the claims 16 to 19, characterized in that, a surface coating is applied to the wheel (1).
